(19) United States
(12) Patent Application Publication
(10) Pub. No.: US 2005/0062869 A1
(43) Pub. Date: Mar. 24, 2005

(54) Immersive video presentations

(76) Inventors: Steven Dwain Zimmermann, Knoxville, TN (US); Christopher Shannon Gourley, Philadelphia, TN (US)

Correspondence Address: FROST BROWN TODD, LLC, 2200 PNC CENTER, 201 E. FIFTH STREET, CINCINNATI, OH, 45202, US

(21) Appl. No.: 10/899,335

(22) Filed: Jul. 26, 2004

Related U.S. Application Data
(62) Division of application No. 09/546,537, filed on Apr. 10, 2000.
(60) Provisional application No. 60/128,613, filed on Apr. 8, 1999.

(51) Int. Cl. H04N 5/225

(52) U.S. Cl. 348/335

(57) ABSTRACT

A system and method for capturing and presenting immersive video presentations is described. A variety of different implementations are disclosed including multiple stream pay-per-view, sporting event coverage and 3D image modeling from the immersive video presentations.

### RELATED REFERENCES

This application claims the benefit of U.S. Provisional Application No. 60/128,613, filed on Apr. 8, 1999, which is hereby entirely incorporated herein by reference. The following disclosures are filed concurrently herewith and are expressly incorporated by reference for any essential material.

1. U.S. patent application Ser. No. ______, (Attorney Docket No. 01096.86946) entitled “Remote Platform for Camera”.

2. U.S. patent application Ser. No. ______, (Attorney Docket No. 01096.86942) entitled “Virtual Theater”.

3. U.S. patent application Ser. No. ______, (Attorney Docket No. 01096.86949) entitled “Method and Apparatus for Providing Virtual Processing Effects for Wide-Angle Video Images”.

### TECHNICAL FIELD

In general, the present invention relates to capturing and viewing images. More particularly, the present invention relates to capturing and viewing spherical images in a perspective-corrected presentation.

### BACKGROUND OF THE INVENTION

With the advent of television and computers, man has pursued the goal of tele-presence: the perception that one is at another place. Television permits a limited form of tele-presence through the use of a single view of a television screen. However, one is continually confronted with the fact that the view provided on a television screen is controlled by another, primarily the camera operator.

Using an example of a roller coaster, a television presentation of a roller coaster ride would generally start with a rider's view. However, the user cannot control the direction of viewing so as to see, for example, the next curve in the track. Accordingly, users merely see what a camera operator intends for them to see at a given location.

Computer systems, through different modeling techniques, attempt to provide a virtual environment to system users. Despite advances in computing power and rendering techniques permitting multi-faceted polygonal representation of objects and three-dimensional interaction with the objects (see, for example, first person video games including Half-life and Unreal), users remain wanting a more realistic experience. So, using the roller coaster example above, a computer system may display the roller coaster in a rendered environment, in which a user may look in various directions while riding the roller coaster. However, the level of detail is dependent on the processing power of the user's computer as each polygon must be separately computed for distance from the user and rendered in accordance with lighting and other options. Even with a computer with significant processing power, one is left with the unmistakable feeling that one is viewing a non-real environment.

### SUMMARY

The present invention discloses an immersive video capturing and viewing system. Through the capture of at least two images, the system allows for a video data set of an environment be captured. The immersive presentation may be streamed or stored for later viewing. Various implementation are described here including surveillance, pay-per-view, authoring, 3D modeling and texture mapping, and related implementations.

In one embodiment, the present invention provides pay-per-view interaction with immersive videos. The present invention provides for the generation of a wide angle image at one location and for the transmission of a signal corresponding to that image to another location, with the received transmission being processed so as to provide a pay-per-view perspective-corrected view of any selected portion of that image at the other location. The present invention provides for the generation of a wide angle image at one location and for the transmission of a signal corresponding to that image to another location, with the received transmission being processed so as to provide at a plurality of stations a perspective-corrected view of any selected portion of that image at any pre-selected positioning with respect to the event being viewed, with each station/user selecting a desired perspective-corrected view that may be varied according to a predetermined pay-per-view scheme.

The present invention provides for the generation of a wide angle image at one location and for the transmission of a signal corresponding to that image to a plurality of other locations, with the received transmission at each location being processed in accordance with pay-per-view user selections so as to provide a perspective-corrected view of any selected portion of that image, with the selected portion being selected at each of the plurality of other locations.

Accordingly, the present invention provides an apparatus that can provide, on a pay-per-view basis, an image of any portion of the viewing space within a selected field-of-view without moving the apparatus to another location, and then electronically correct the image for visual distortions of the view.

The present invention provides for the pay-per-view user to select the degree of magnification or scaling desired for the image (zooming in and out) electronically, and where desired, to provide multiple images on a plurality of windows with different orientations and magnification simultaneously from a single input spherical video image.

A pay-per-view system may produce the equivalent of pan, tilt, zoom, and rotation within a selected view, transforming a portion of the video image based upon user or pre-selected commands, and producing one or more output images that are in correct perspective for human viewing in accordance with the user pay-per-view selections. In one embodiment, the incoming image is produced by a fisheye lens that has a wide angle field-of-view. This image is captured into an electronic memory buffer. A portion of the captured image, either in real time or as prerecorded, containing a region-of-interest is transformed into a perspective corrected image by an image processing computer. The image processing computer provides mapping of the image region-of-interest into a corrected image using, for example, an orthogonal set of transformation algorithms. The original image may comprise a data set comprising all effective information captured from a point in space. Allowance is made for the platform (tripod, remote control robot, stalk supporting the lens structure, and the like). Further, the data set may be modified by eliminating the top and bottom portions as, in some instances, these regions do not contain unique material (for example, when straight vertical only looks at a clear sky). The data set may be stored in a variety of formats including equirectangular, spherical (as shown, for example, in U.S. Pat. Nos. 5,684,937, 5,903,782, and 5,936,630 to Oxaal), cubic, bi-hemispherical, panoramic, and other representations as are known in the art. The conversion from one representation to others is within the scope of one of ordinary skill in the art.

The viewing orientation is designed by a command signal generated by either a human operator or computerized input. The transformed image is deposited in an electronic memory buffer where it is then manipulated to produce the output image or images as requested by the command signal.

The present invention may utilize a lens supporting structure which provides alignment of for an image capture means wherein the alignment produces captured images that are aligned for easy seaming together of the captured images to form spherical images that are used to produce multiple streams for providing viewing of an event at different positions/locations by a pay-per view user.

A video apparatus with that camera having at least two wide-angle lenses, such as a fish-eye lens with field-of-views of at least 180 degrees, produces electrical signals that correspond to images captured by the lenses. It is appreciated that three 120 or more degree lenses may be used (for example, three 180 degree lenses producing an overlap of 60 degrees per lens). Further, four 90 or more degree lenses may be used as well.

These electrical signals, which are distorted because of the curvature of the lens, are input to apparatus, digitized, and seamed together into an immersive video. Despite some portions being blocked by a supporting platform (for example, as described in concurrently filed U.S. Ser. No. ______ (01096.86946) entitled “Remote Platform for Camera”, whose contents are incorporated herein, the resulting immersive video provides a user with the ability to navigate to a desired viewing location while the video is playing.

The immersive video may have portions After creating each spherical video image, the apparatus may transmit a portion representing a view selected by the pay-per-view user, or alternatively, may compress each image using standard data compression techniques and then store the images in a magnetic medium, such as a hard disk, for display at real time video rates or send compressed images to the user, for example over a telephone line.

At each pay-for-play location where viewing is desired, there is apparatus for receiving the transmitted signal. In the case of the telephone line transmission, “decompression” apparatus is included as a portion of the receiver. The received signal is then digitized. A selected portion of the multi-stream transmission of the pay-for-play view of the event is selected by the pay-for-play viewer and a selected portion of the digitized signal, as selected by operator commands, is transformed using the algorithms of the above-cited U.S. Pat. No. 5,185,667 into a perspective-corrected view corresponding to that selected portion. This selection by operator commands includes options of pan, tilt, and rotation, as well as degrees of magnification.

Command signals are sent by the pay-for-play user to at least a first transform unit to select the portion of the multi-stream transmission of the viewing event that is desired to be seen by the user.

These and other objects of the present invention will become apparent upon consideration of the drawings hereinafter in combination with a complete description thereof.

### BRIEF DESCRIPTION OF THE DRAWINGS

FIG. 1 shows a block diagram of a single lens image capture system in accordance with embodiments of the present invention.

FIG. 2 shows a block diagram of a multiple lens image capture in accordance with embodiments of the present invention.

FIG. 3 shows a tele-centrically-opposed image capture system in accordance with embodiments of the present invention.

FIG. 4 shows an alternative image capture system in accordance with embodiments of the present invention.

FIG. 5 shows yet another alternative image capture system in accordance with embodiments of the present invention.

FIG. 6 shows a developing process flow in accordance with embodiments of the present invention.

FIG. 7 shows various image capture systems and distribution systems in accordance with embodiments of the present invention.

FIG. 8 shows various seaming systems in accordance with embodiments of the present invention.

FIG. 9 shows distribution systems in accordance with embodiments of the present invention.

FIG. 10 shows a file format in accordance with embodiments of the present invention.

FIG. 11 shows alternative image representation data structures in accordance with embodiments of the present invention.

FIG. 12 shows a temporal hotspot actuation process in accordance with embodiments of the present invention.

FIG. 13 shows a pay-per-view process in accordance with embodiments of the present invention.

FIG. 14 shows a pay-per-view system in accordance with embodiments of the present invention.

FIG. 15 shows another pay-per-view system in accordance with embodiments of the present invention.

FIG. 16 shows yet another pay-per-view system in accordance with embodiments of the present invention.

FIG. 17 shows a stadium with image capture points in accordance with embodiments of the present invention.

FIG. 18 provides a representation of the images captured at the image capture points of FIG. 17 in accordance with embodiments of the present invention.

FIG. 19 shows the image capture perspectives with additional perspectives in accordance with embodiments of the present invention.

FIG. 20 shows another perspective of the system of FIG. 19 with a distribution system in accordance with embodiments of the present invention.

FIG. 21 shows an effective field of view concentrating on a playing field in accordance with embodiments of the present invention.

FIG. 22 shows a system for overlaying generated images on an immersive presentation stream in accordance with embodiments of the present invention.

FIG. 23 shows an image processing system for replacing elements in accordance with embodiments of the present invention.

FIG. 24 shows a boxing ring in accordance with embodiments of the present invention.

FIG. 25 shows a pay-per-view system in accordance with embodiments of the present invention.

FIG. 26 shows various image capture systems in accordance with embodiments of the present invention.

FIG. 27 shows image analysis points as captured by the systems of FIG. 26 in accordance with embodiments of the present invention.

FIG. 28 shows various images as captured with the systems of FIG. 26 in accordance with embodiments of the present invention.

FIG. 29 shows a laser range finder with an immersive lens combination in accordance with embodiments of the present invention.

FIG. 30 shows a three-dimensional model extraction system in accordance with embodiments of the present invention.

FIGS. 31A-C show various implementations of the system in applications in accordance with embodiments of the present invention.

### DETAILED DESCRIPTION

The system relates to an immersive video capture and presentation system. In capturing and presenting immersive video presentations, the system, through the use of 180 or more degree fish eye lenses, captures 360 degrees of information. As will be appreciated from the description, other lens combinations may be used as well including cameras equipped with lenses of less than 180 degrees fields of view and capturing separate images for seaming. Further, not all data needs to be captured to accomplish the goals of the present invention. Specifically, panoramic data sets may be used, as not having a top or bottom portion (e.g., top or bottom 20 degrees). Moreover, data sets of more than 360 degrees may be used (for example, 370 (from two 185 degree lenses) or 540 degrees (from three 180 degree lenses) for additional image capture. Accordingly, for simplicity, reference is made to 360 degree views or spherical data sets. However, it is readily appreciated that alternative data sets or videos with different amounts of coverage (greater or less than) may be used equally as well.

It is appreciated that all methods may be implemented in computer readable mediums in addition to hardware.

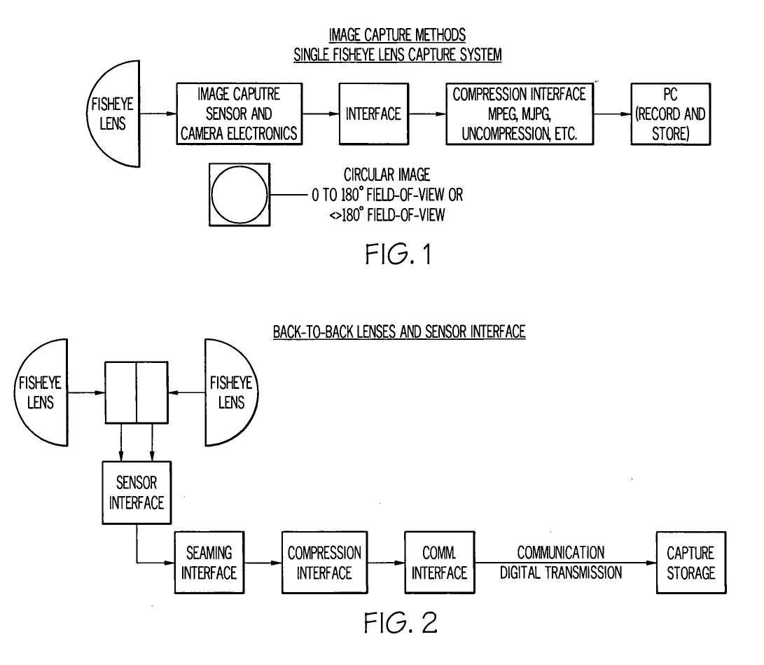

FIG. 1 shows a block diagram of a single lens image capture system in accordance with embodiments of the present invention. FIG. 1 is a block diagram of one embodiment of an immersive video image capture method using a single fisheye lens capture system for use with the present invention. The system includes a fish-eye lens (which may be greater or less than 180 degrees), an image capture sensor and camera electronics, a compression interface (permitting compression to different standards including MPEG, MJPG, and even not compressing the file), and a computer system for recording and storing the resulting image. Also shown in FIG. 1 is a resulting circular image as captured by the lens. The image capture system as shown in FIG. 1 captures images and outputs the video stream to be handled by the compression system.

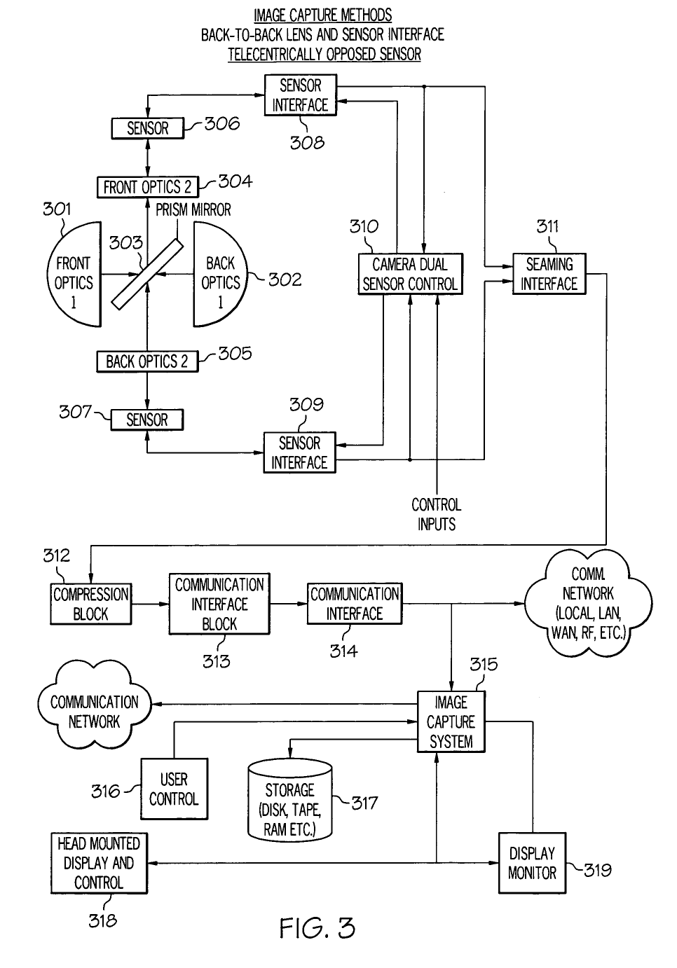

FIG. 2 shows a block diagram of a multiple lens image capture in accordance with embodiments of the present invention. FIG. 2 shows two back to back camera systems (as shown in U.S. Pat. No. 6,002,430, which is incorporated by reference), a sensor interface, a seaming interface, a compression interface, and a communication interface for transmitting the received video signal onto a communications system. The received transmission is then stored in a capture/storage system.

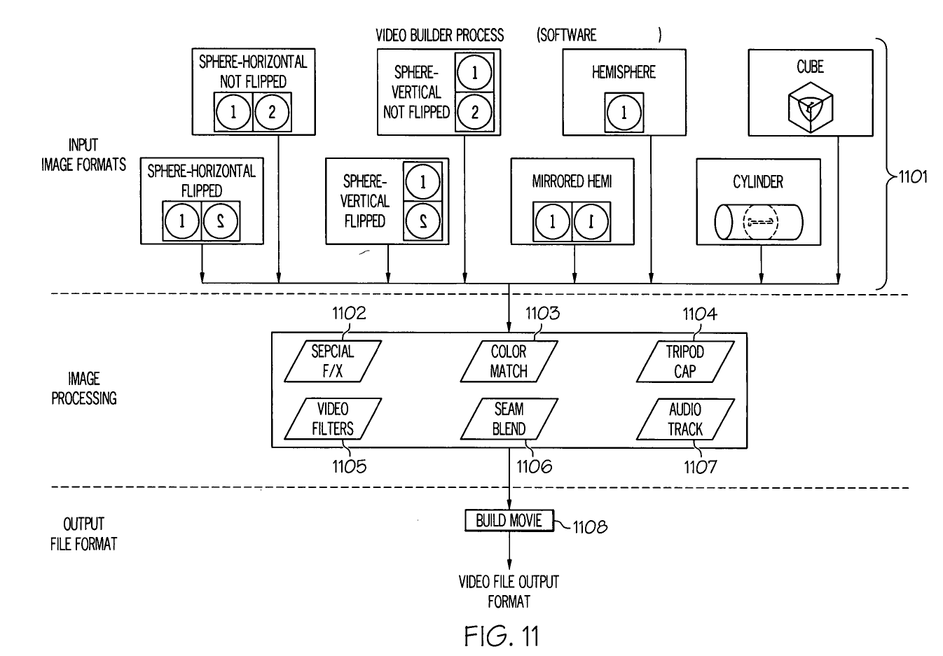

FIG. 3 shows a tele-centrically-opposed image capture system in accordance with embodiments of the present invention. FIG. 3 details a first objective lens 301 and a second objective lens 302. Both objective lenses transmit their received images to a prism mirror 303 which reflects the image from objective lens 301 up and the image from objective lens 302 down. Supplemental optics 304 and 305 may then be used to form the images on sensors 306 and 307. An advantage to having tele-centrically opposed optics as shown in FIG. 3 is that the linear distance between lens 301 and lens 302 may be minimized. This minimization attempts to eliminate non-captured regions of an environment due to the separation of the lenses. The resulting images are then sent to sensor interfaces 308, 309 as controlled by camera dual sensor control 301. Camera dual sensor interface 310 may receive control inputs addressing irising among the two optical paths, color matching between the two images (due to, for example, color variations in the optics 301, 302, 304, 305, and in the sensors 306, 307), and other processing as further defined in FIG. 11 and in U.S. Ser. No. ______ (01096.86949), referenced above. Both image streams are input into a seaming interface where the two images are aligned. The alignment may take the form of aligning the first pair, or sets of pairs and applying the correction to all remaining images, or at least the images contained in a captured video scene.

The seamed video is input into compression system 312 where the video may be compressed for easier transmission. Next, the compressed video signal is input to communication interface block 313 where the video is prepared for transmission. The video is next transmitted via communication interface 314 to a communications network. Receiving the video from the communications network is an image capture system (for example, a user's computer) 315. A user specifies 316 a selected portion or portions of the video signal. The portions may comprise directions of view (as detailed in U.S. Pat. No. 5,185,667, whose contents are expressly incorporated herein). The selected portion or portions may originate with a mouse, joystick, positional sensors on a chair, and the like as are known in the art and further including a head mounted display with a tracking system. The system further includes a storage 317 (which may include a disk drive, RAM, ROM, tape storage, and the like). Finally, a display is provided as 319. The display may take the shape of the display systems as embodied in U.S. Ser. No. ______ (01096.86942).

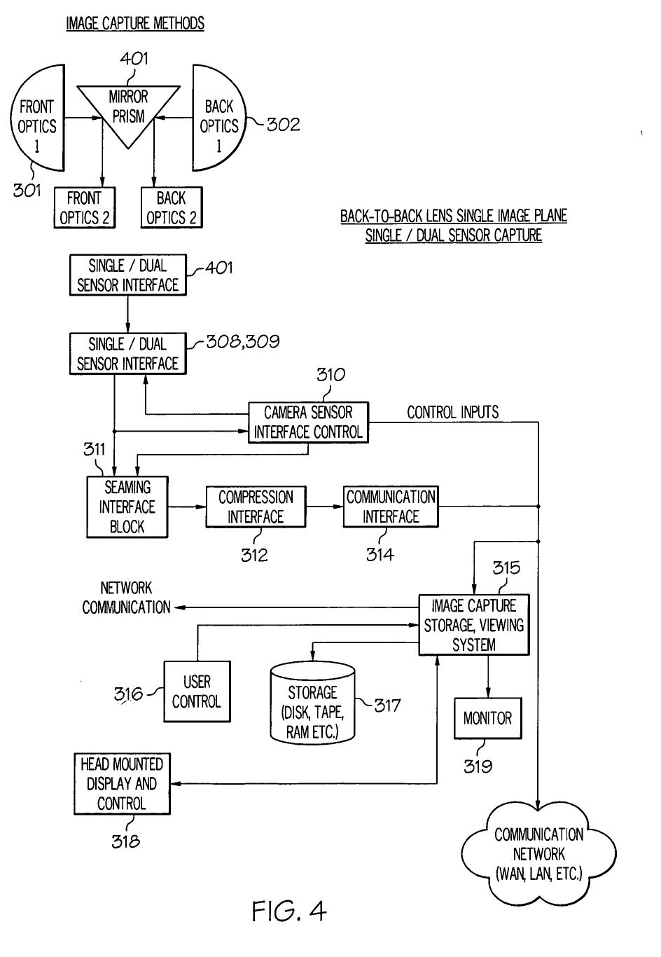

FIG. 4 shows an alternative image capture system in accordance with embodiments of the present invention. Similar to that of FIG. 3, FIG. 4 shows an image capture system with a mirror prism directing images from the objective lenses to a common sensor interface. The sensor interface 401 may be a single sensor or a dual sensor. Other elements are similar to those of FIG. 3.

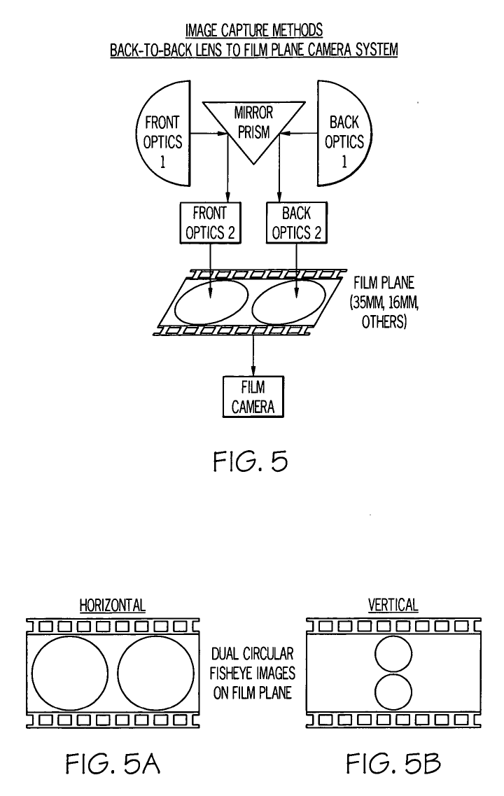

FIG. 5 shows yet another alternative image capture system in accordance with embodiments of the present invention. FIG. 5 shows an embodiment similar to that of FIG. 4 but using light sensitive film. In this embodiment, different film sizes (35 mm, 16 mm, super 35 mm, super 16 mm and the like) may be used to capture the image or images from the optics. FIG. 5 shows different orientations for storing images on the film. In particular, the images may be arranged horizontally, vertically, etc. An advantage of the super 16 mm and super 35 mm film formats is that the approximate a 2:1 aspect ratio. With this ratio, two circular images from the optics may be captured next to each other, thereby maximizing the amount of a frame of film used.

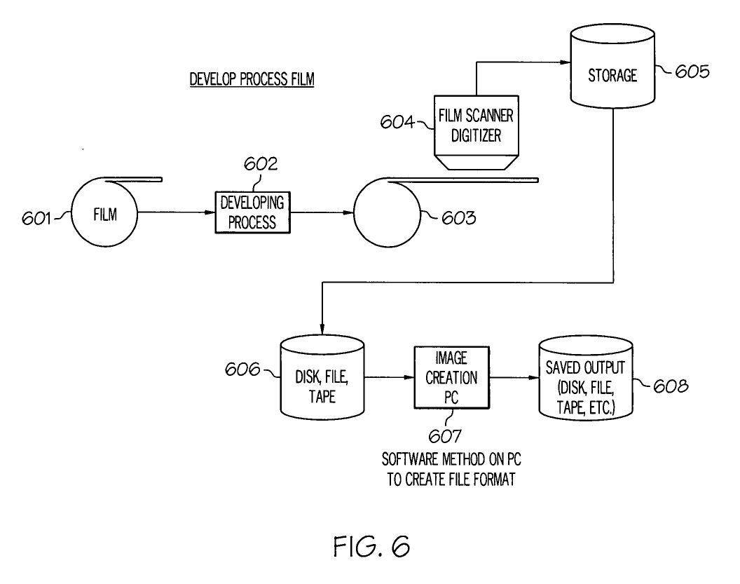

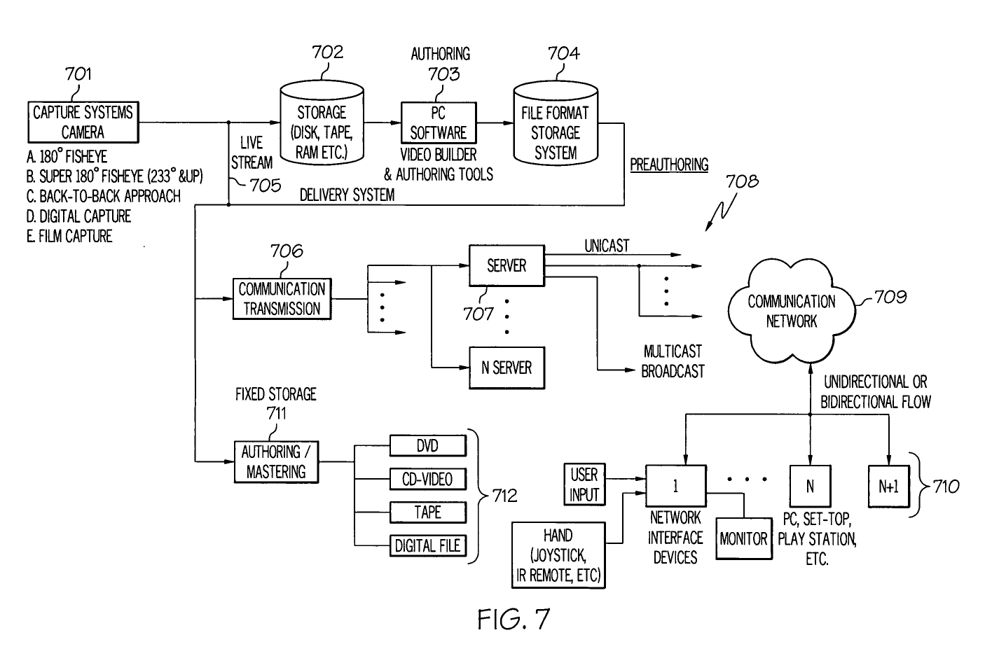

FIG. 6 shows a process flow for developing and processing the film from the film plane into an immersive movie. The film 601 is developed in developer 602. The developed film 603 is scanned by scanner 604 and the result is stored in scanner 605. The storage may also comprise a disk, diskette, tape, RAM or ROM 606. The images are seamed together and melded into an immersive presentation in 607. Finally, the output is stored in storage 608 FIG. 7 shows various image capture systems and distribution systems in accordance with embodiments of the present invention. Capture system cameras 701 may represent 180 degree fish eye lenses, super 180 (233 degrees and greater) fish eye lenses, the various back to back image capture devices shown above, digital image capture, and film capture. The result of the image capture in 701 may be sent to a storage 702 for processing by authoring tools 703 and later storage 704, or may be streamed live 705 to a delivery/distribution system. The communication link 706 distributes the stored information and sends it at least one file server 707 (which may comprise a file server for a web site) so as to distribute the information over a network 709. The distribution system may comprise a unicast transmission or a multicast 708 as these techniques of distributing data files are known in the art. The resulting presentations are received by network interface devices 710 and used by users. The network interface devices may include personal computers, set-top boxes for cable systems, game consoles, and the like. A user may select at least one portion of the resulting presentation with the control signals being sent to the network interface device to render a perspective correct view for a user.

Instead of transmitting the presentation over a network (e.g., the Internet), the presentation may be separately authored or mastered 711 and placed in a fixed medium 712 (that may include DVDs, CD-ROMs, CD-Videos, tapes, and in solid state storage (e.g., Memory Sticks by the Sony Corporation).

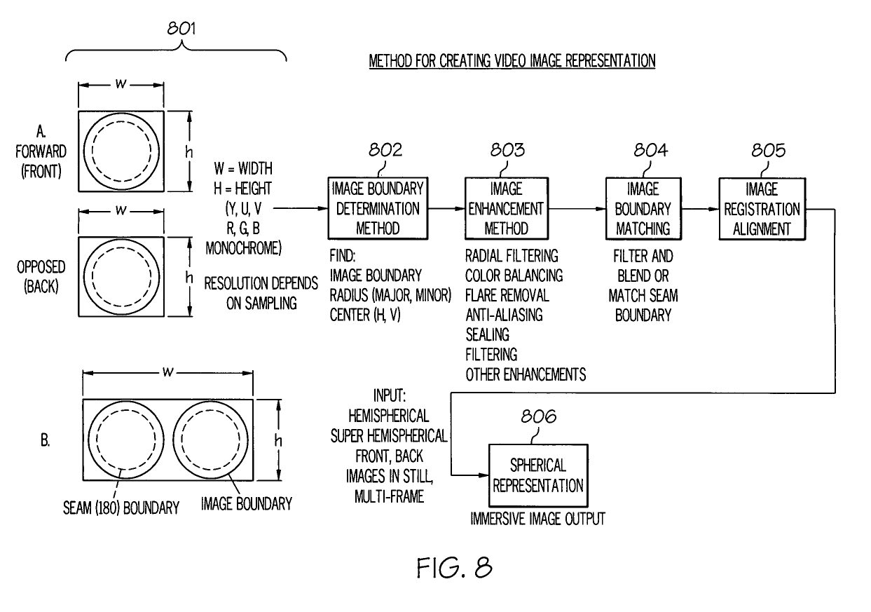

FIG. 8 shows various seaming systems in accordance with embodiments of the present invention. Input images may comprise two or more separate images 801A or combined images with two spherical images on them 801B. 801A and 801B show an example where lenses of greater than 180 degrees were used to capture an environment. Accordingly, an image boundary is shown and a 180-degree boundary is shown on each image. By defining the 180 degree boundary, one is able to more easily seam images as one would know where overlapping portions of the image being and end. Further, the resolution of the resulting image may depend on the sampling method used to create the representations of 801A and 801B. The boundaries of the image are detected in system 802. The system may also find the radius of the image circle. In the case of offsets or warping to an ellipse, major and minor radii may be found. Further, from these values, the center of the image may be found (h,v). Next, image enhancement methods may be applied in step 803 if needed. The enhancement methods may include radial filtering (to remove brightness shifts as one moves from the center of the lens), color balancing (to account for color shifts due to lens color variations or sensor variations, for example, having a hot or cold gamma), flare removal (to eliminate lens flare), anti-aliasing, scaling, filtering, and other enhancements. Next, the boundaries of the images are matched 804 where one may filter or blend or match seams along the boundaries of the images. Next, the images are brought into registration through the registration alignment process 805. These and related techniques may be found in co-pending PCT Reference No. PCT/US99/07667 filed on Apr. 8, 1999, whose disclosure is incorporated by reference.

Finally, the seaming and alignment applied in step 805 is applied to the remaining video sequences, resulting in the immersive image output 806.

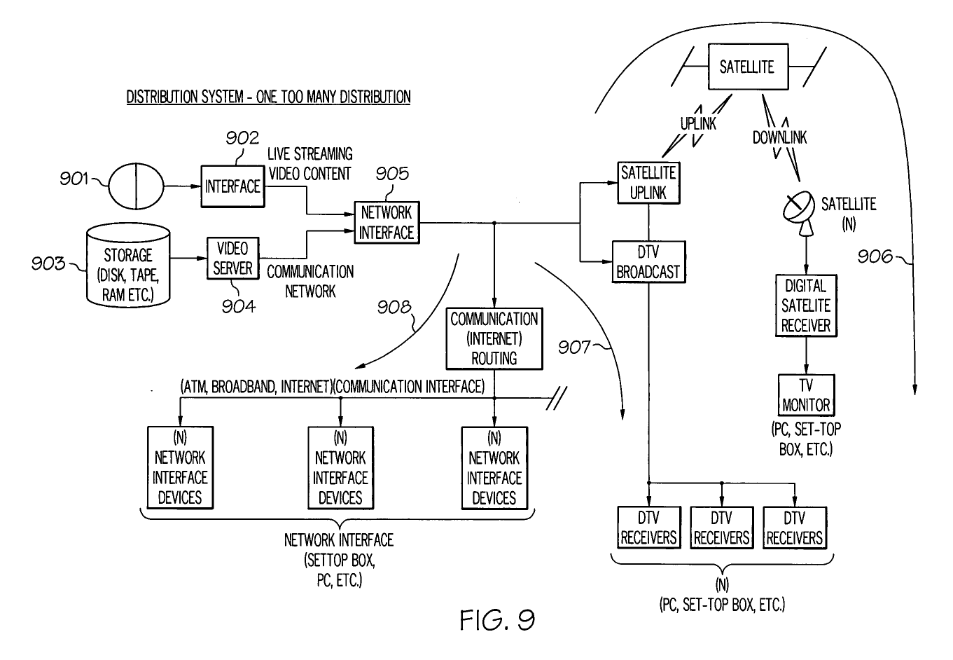

FIG. 9 shows distribution systems in accordance with embodiments of the present invention. Immersive video sequences are received at a network interface 905 (from lens system 901 and combination interfaces 902 or storage 903 and video server 904). The network interface outputs the image via a satellite link 906 to viewers (including set-top boxes, personal computers, and the like). Alternatively, the system may broadcast the immersive video presentation via a digital television broadcast 907 to receiver (comprising, for example, set-top boxes, personal computers, and the like). Moreover, the immersive video experience may be transmitted via ATM, broadband, the Internet, and the like 908. The receiving devices may be personal computers, set-top boxes and the like.

Likewise, global positioning system data may be captured simultaneously with the image or by pre-recording or post-recording the location data as is known from the surveying art. The object is to record the precise latitude and longitude global coordinates of each image as it is captured. Having such data, one can easily associate front and back hemispheres with one another for the same image set (especially when considered with time and date data). The path of image taking from one picture to the next can be permanently recorded and used, for example, to reconstruct a picture tour taken by a photographer when considered with the date and time of day stamps.

Other data may be automatically recorded in memory as well (not shown) including names of human subjects, brief description of the scene, temperature, humidity, wind velocity, altitude and other environmental factors. These auxiliary digital data files associated with each image captured would only be limited in type by the provision of appropriate sensing and/or measuring equipment and the access to digital memory at the time of image capture. One or more or all of these capabilities may be built into wide angle digital camera system.

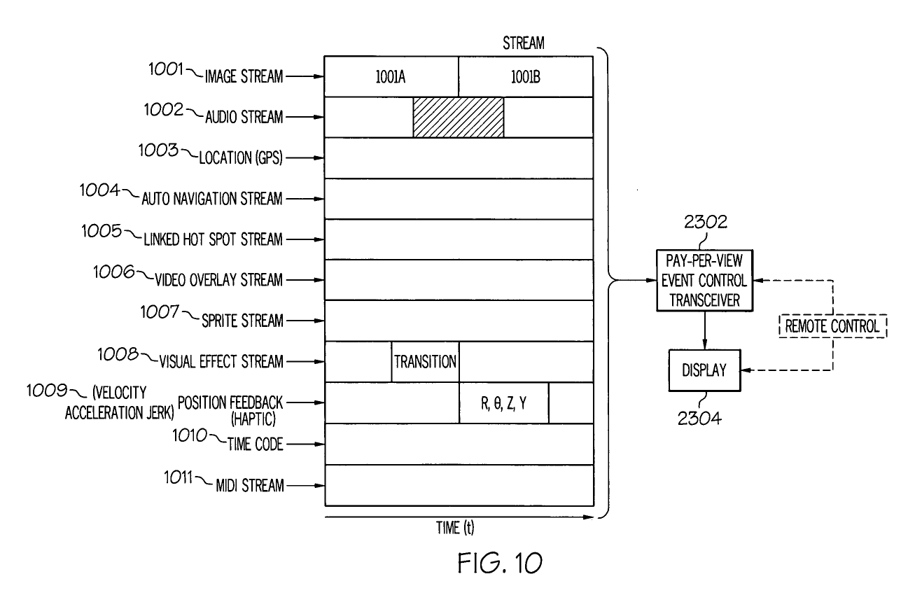

FIG. 10 shows a file format in accordance with embodiments of the present invention. The file format comprises at data structure as including an immersive image stream 1001 and an accompanying audio stream 1002. Here, immersive image stream 1001 is shown with two scenes 1001A and 1001B. In one embodiment, the audio stream is spatially encoded. In another embodiment, the audio portion is not so encoded. By encoding the audio stream, the user is presented with a more immersive experience. However, by not encoding the stream, the amount of non-image formation transmitted is reduced. The technique for spatial encoding is described in greater detail in U.S. Ser. No. ______ (01096.86942) entitled “Virtual Theater”, filed herewith and incorporated by reference. To minimize data content and attempt to increase image transfer rates, one embodiment only uses the combination of the image stream and the audio stream to provide the immersive experience. However, alternate embodiments permit the addition of additional information that enables tracking of where the immersive image was captured (location information 1003 including, for example, GPS information), enables the immersive experience to have a predefined navigation (auto navigation stream 1004), enables linking between immersive streams (linked hot spot stream 1005), enables additional information to be overlaid onto the immersive video stream (video overlay stream 1006), enables sprite information to be encoded (sprite stream 1007), enables visual effects to be combined on the image stream (visual effects stream 1008 which may incorporate transitions between scenes), enable position feedback information to be recorded (position feedback stream 1009), enables timing (time code 1010), and enhanced music to be added (MIDI stream 1011). It is appreciated that various ones of the data format fields may be added and removed as needed to increase or decrease the bandwidth consumed and file size of the immersive video presentation.

FIG. 10 also shows an embodiment where the pay-per-view embodiment of the present invention uses the described data format. For example, the pay-per-view embodiment allows a user to select a location for viewing an event, such as for example, the 20 yard line for a football game, and the delivery system isolates the data needed from the spherical video image that will provide a view from the selected location and sends it to the pay-for-view event control transceiver 2302 for viewing on a display 2304 by the user. The user may select a plurality of locations for viewing that may be delivered to a plurality of windows on his display. Also, the user may adjust a view using pan, tilt, rotate, and zoom. In addition, the viewing location may be associated with an object that is moving in the event. For example, by selecting the basketball as the location of the view, the display will place the basketball at or near the center of the window and will track the movement of the basketball, i.e., the window will show the basketball at or near the center of the screen and the camera will follow the movement of the basketball by shifting the display to maintain the basketball at or near the center of the screen as the basketball game proceeds. In a sport such as golf, the display maybe adjusted to zoom back to encompass a large area and place a visible screen marker on the golf ball, and where selected by the user, may leave a path such as is seen with “mouse tails” on a computer screen when the mouse is moved, to facilitate the user's viewing of the path of the golf ball.

In short, a pay-per-view system may transmit the entire immersive presentation and let the user determine the direction of view and, alternatively, the system may transmit only a pre-selected portion of the immersive presentation for passive viewing by a consumer. Further, it is appreciated that a combination of both may be used in practice of the invention without undue experimentation.

FIG. 11 shows alternative image representation data structures in accordance with embodiments of the present invention. The top portion of FIG. 11 shows different image formats that may use used with the present invention. The image formats include: front and back portions of a sphere not flipped, sphere-vertical not flipped, a single hemisphere (which may also be a spherical representation as shown in U.S. Pat. Nos. 5,684,937, 5,903,782, 5936,630 to Oxaal), a cube, a sphere-horizontal flipped, a sphere vertical flipped, a pair of mirrored hemispheres, and a cylindrical view, all collectively shown as 1101.

The input images are input into an image processing section (as described in U.S. patent application Ser. No. ______, (Attorney Docket No. 01096.86949) entitled “Method and Apparatus for Providing Virtual Processing Effects for Wide-Angle Video Images”). The image processing section may include some or all of the following filters including a special effects filter 1102 (for transitioning between scenes, for example, between scenes 1001A and 1001B). Also, video filters 1105 may include a radial brightness regulator that accommodates for image loss of brightness. Color match filter 1103 adjusts the color of the received images from the various cameras to account for color offsets from heat, gamma corrections, age, sensor condition, and other situations as are known in the art. Further, the system may include a image segment replicator to replicate pixels around a portion of an image occulted by a tripod mount or other platform supporting structure. Here, the replicator is shown as replacing a tripod cap 1104. Seam blend 1106 allows seams to be matched and blended as shown in PCT/US99/07667 filed Apr. 8, 1999. Finally, process 1107 adds an audio track that may be incorporated as audio stream 1002 and/or MIDI stream 1011. The output of the processors results in the immersive video presentation 1108.

Referring to FIG. 10, linked hot spot stream 1005 provides and removes hot spots (links to other immersive streams) when appropriate. For instance, in one example, a user's selection of a region relating to a hot spot should only function when the object to which the hot spot links is in the displayed perspective corrected image. Alternatively, hot spots may be provided along the side of a screen or display irrespective of where the immersive presentation is during playback. In this alternative embodiment, the hot spots may act as chapter listings.

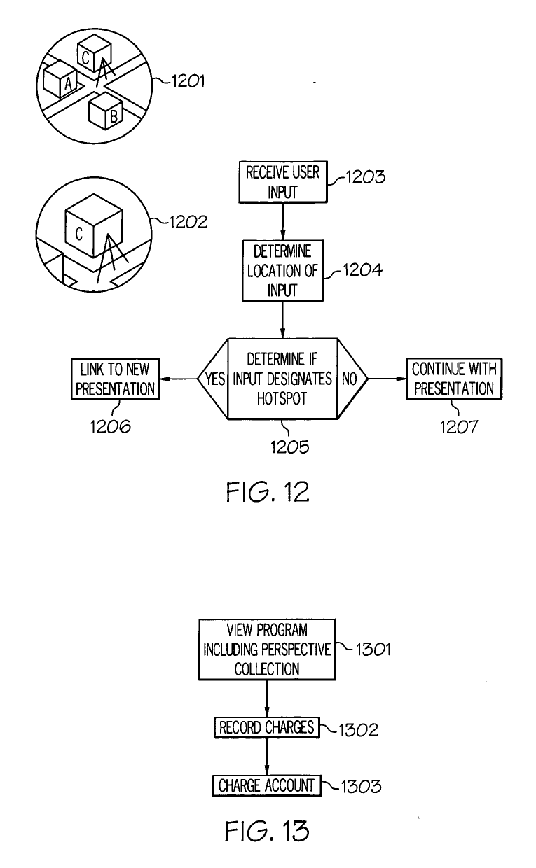

FIG. 12 shows a process for acting on the hot spot stream 1005. For reference, image 1201 shows three homes for sale during a real estate tour as may be viewed while virtually driving a car. While proceeding down the street from image 1201 to 1202, houses A and B are not longer in view. In one embodiment, the hotspot linking to immersive video presentations of houses A and B (for example, tours of the grounds and the interior of the houses) are removed from the hot spots available to the viewer. Rather, only a hot spot linking to house C is available in image 1202. Alternatively, all hot spots may be separately accessible to a user as needed for example on the bottom of a displayed screen or through keyboard or related input. The operation of the hot spots is discussed below. In step 1203, a user's input is received. It is determined in step 1204 where the user's input is located on the image. In step 1205 it is determined if the input designates a hot spot. If yes, the system transitions to a new presentation 1206. If not, the system continues with the original presentation 1207. As to the pay-per-view aspect of the present invention, the system allow one to charge per viewing of the homes on a per use basis. The tally for the cost for each tour may be calculated based on the number of hot spots selected.

FIG. 13 shows another method of deriving an income stream from the use of the described system. In step 1301, a user views a presentation with reception of user information directing the view. If a user activates the change in field of view to, for example, follow the movement of the game or to view alternative portions of a streamed image, the user may be charged for the modification. The record of charges is compiled in step 1302 and the charge to account occurring in step 1303.

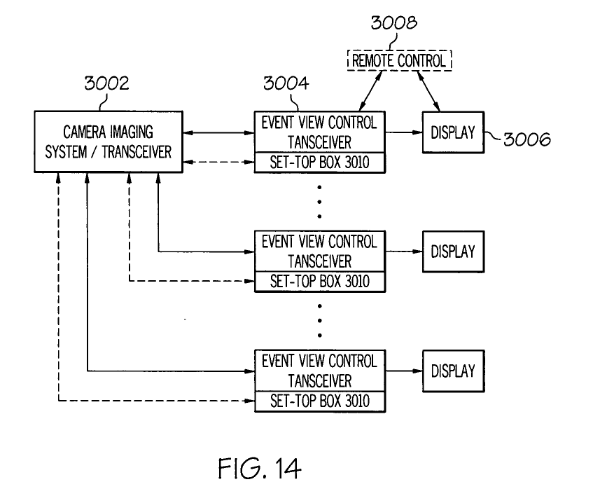

FIG. 14 shows a pay-per-view system in accordance with embodiments of the present invention. The invention provides a pay-per-view delivery system that delivers at least a selected portion of video images for at least one view of the event selected by a pay-per-view user. The event is captured in spherical video images via multiple streaming data streams. The portion of the streaming data streams representing the view of the event selected by the pay-per-view user. More than one view may be selected and viewed using a plurality of windows by the user. Typically, the event is captured using at least one digital wide angle or fisheye lens. The pay-for-view delivery system includes a camera imaging system/transceiver 3002, at least one event view control transceiver 3004, and a display 3006. In this embodiment, the camera imaging system/transceiver includes at least two wide-angle lenses or a fisheye lens and, upon receiving control signals from the user selecting the at least one view of the event, simultaneously captures at least two partial spherical video images for the event, produces output video image signals corresponding to said at least two partial spherical video images, digitizing the output video image signals, and, where needed, the digitizer includes a seamer for seaming together said digitized output video image signals into seamless spherical video images and a memory for digitally storing or buffering data representing the digitized seamless spherical video images, and sends digitized output video image signals for the at least one portion of the multiple streaming data streams representing the at least one event to the event control transceiver. The memory may also be utilized for storing billing data. Capturing the spherical video images may be accomplished as described, for example, in U.S. Pat. No. 6,002,430 (Method and Apparatus For Simultaneous Capture Of A Spherical Image by Danny A. McCall and H. Lee Martin). Thus, upon capturing the spherical video images in a stream, the camera imaging system/transceiver digitizes and seams together, where needed, the images and sends the portion for the selected view to the at least one event view control transceiver.

The at least one event view control transceiver 3004 is coupled to send control signals activated by the user selecting the at least one view of the event and to receive the digitized output video image signals from the camera-imaging system/transceiver 3002. The event view control transceiver 3004 typically is in the form of a handheld remote control 3008 and a set-top box 3010 coupled to a video display system such as a computer CRT, a television, a projection display, a high definition television, a head mounted display, a compound curve torus screen, a hemispherical dome, a spherical dome, a cylindrical screen projection, a multi-screen compound curve projection system, a cube cave display, or a polygon cave. However, where desired, event view control transceiver may have the controls in the set-top box. Where a remote control devise is used, the handheld remote control portion of the event view control transceiver is arranged to communicate with a set-top box portion of the event view control transceiver so that the user may more conveniently issue control signals to the pay-per-view delivery system and adjust the selected view using pan, tilt, rotate, and zoom adjustments. In one embodiment, the remote control portion has a touch screen with controls for the particular event shown thereon. The use simply inputs the location of the event (typically the channel and time), touches the desired view and the pan, tilt, rotate, and zoom as desired, to initiate viewing of the event at the desired view. The event view controls send control signals indicating the at least one view for the event. The event view control transceiver receives at least the digitized portion of the output video image signals that encompasses said view/views selected and uses a transformer processor to process the digitized portion of the output video image signals to convert the output video image signals representing the view/views selected to digital data representing a perspective-corrected planar image of the view/views selected.

The display is coupled to receive and display streaming data for the perspective-corrected planar image of the view/views for the event in response to the control signals. The display may show the at least one view or a plurality of views in a plurality of windows on the screen. For example, one may show the front view from a platform and the side view or back view off the platform. Each window may simultaneously display a view that is simultaneously controllable by separate user input of any combination of pan, tilt, rotate, and zoom.

The event View controls may include switchable channel controls to facilitate user selection and viewing of alternative/additional simultaneous views as well as controls for implementing pan, tilt, rotate, and zoom settings. Generally billing is based on a number of views selected for a predetermined time period and a total viewing time utilized. Billing may be accomplished by charging an amount due on to a predetermined credit card of the user, automatically deducting an amount due from a bank account of the user, sending a bill for an amount due to the user, or the like.

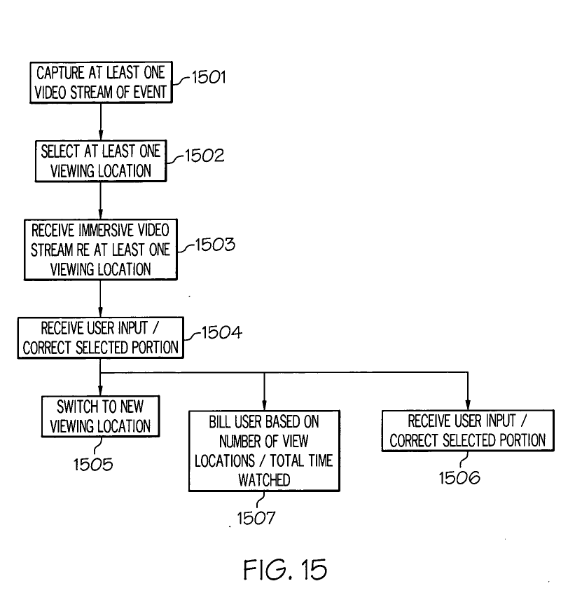

FIG. 15 shows another pay-per-view system in accordance with embodiments of the present invention.

The invention provides a method for displaying at least one view location of an event for a pay-per-view user utilizing streaming spherical video images. The steps of the method include: sequentially capturing a video stream of an event 1501, selecting at least one viewing location, receiving an immersive video stream regarding the at least one viewing location 1503, receiving a user input and correcting a selected portion for viewing 1504.

The method may further include the steps of dynamically switching/adding 1505 a portion of the streaming spherical video images in accordance with selecting, by the user, alternative/additional simultaneous view locations. The method may also include receiving user input regarding the new selection and perspective correcting the new portion 1506. The method may include the step of billing 1507 based on a number of view locations selected for the time period and, alternatively or in combination, billing for a total time viewing the image stream. Billing is generally implemented by charging an amount due on to a predetermined credit card of the user, automatically deducting an amount due from a bank account of the user, or sending a bill for an amount due to the user. Viewing is typically accomplished via one of: a computer CRT, a television, a projection display, a high definition television, a head mounted display, a compound curve torus screen hemispherical dome, a spherical dome, a cylindrical screen projection, a multi-screen compound curve projection system, a cube cave display, and a polygon cave (as are discussed in U.S. Ser. No. ______ (01096.86942) entitled “Virtual theater.”

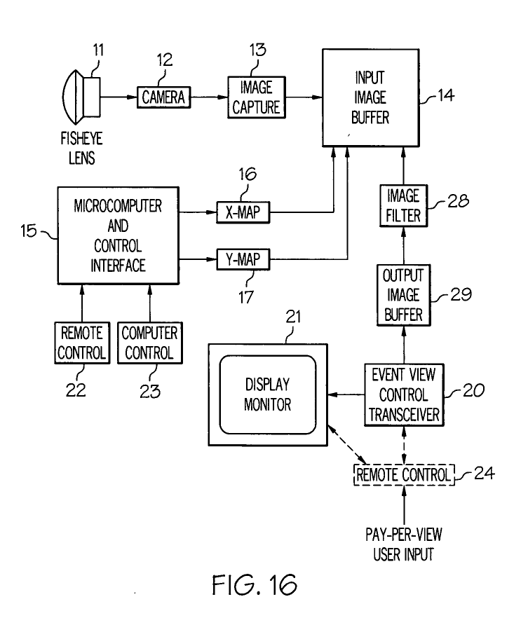

FIG. 16 shows yet another pay-per-view system in accordance with embodiments of the present invention. Shown schematically at 11 is a wide angle, e.g., a fisheye, lens that provides an image of the environment with a 180 degree field-of-view. The lens is attached to a camera 12 which converts the optical image into an electrical signal. These signals are then digitized electronically in an image capture unit 13 and stored in an image buffer 14 within the present invention. An image processing system consisting of an X-MAP and a Y-MAP processor shown as 16 and 17, respectively, performs the two-dimensional transform mapping. The image transform processors are controlled by the microcomputer and control interface 15. The microcomputer control interface provides initialization and transform parameter calculation for the system. The control interface also determines the desired transformation coefficients based on orientation angle, magnification, rotation, and light sensitivity input from an input means such as a joystick controller 22 or computer input means 23. The transformed image is filtered by a 2-dimensional convolution filter 28 and the output of the filtered image is stored in an output image buffer 29. The output image buffer 29 is scanned out by display electronics/event view control transceiver 20 to a video display monitor 21 for viewing. Where desired, a remote control 24 may be arranged to receive user input to control the display monitor 21 and to send control signals to the event view control transceiver 29 for directing the image capture system with respect to desired view or views which the pay-per-view user wants to watch.

The user of software may view perspectively correct smaller portions and zoom in on those portions from any direction as if the user were in the environment, causing a virtual reality experience.

The digital processing system need not be a large computer. For example, the digital processor may comprise an IBM/PC-compatible computer equipped with a Microsoft WINDOWS 95 or 98 or WINDOWS NT 4.0 or later operating system. Preferably, the system comprises a quad-speed or faster CD-ROM drive, although other media may be used such as Iomega ZIP discs or conventional floppy discs. An Apple Computer manufactured processing system M should have a MACINTOSH Operating System 7.5.5 or later operating system with QuickTime 3.0 software or later installed. The user should assure that there exists at least 100 megabits of free hard disk space for operation. An Intel Pentium 133 MHz or 603c PowerPC 180 MHz or faster processor is recommended so the captured images may be seamed together and stored as quickly as possible. Also, a minimum of 32 megabits of random access memory is recommended.

Image processing software is typically produced as software media and sold for loading on digital signal processing system. Once the software according to the present invention is properly installed, a user may load the digital memory of processing system with digital image data from digital camera system, digital audio files and global positioning data and all other data described above as desired and utilize the software to seam each two hemisphere set of digital images together to form IPIX images.

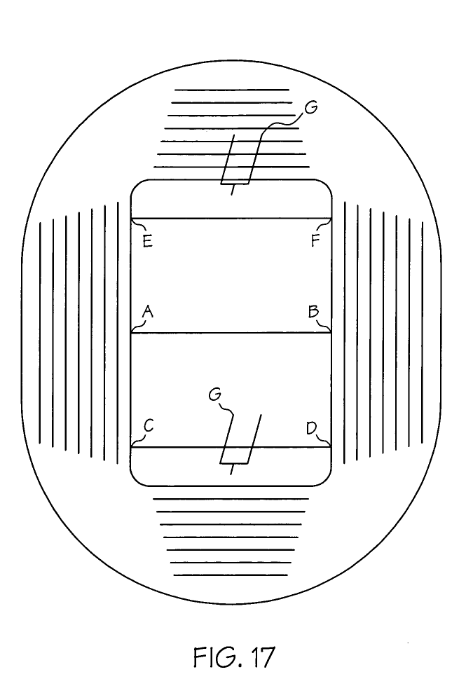

FIG. 17 shows a stadium with image capture points in accordance with embodiments of the present invention. Relates to another event capture system. FIG. 17 depicts a sport stadium with event capture cameras located at points A-F. To show the flexibility of placing cameras, cameras G are placed on the top of goal posts.

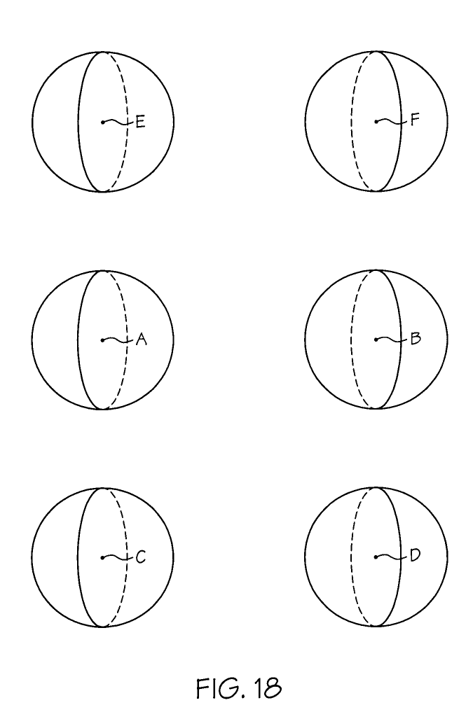

FIG. 18 provides a representation of the images captured at the image capture points of FIG. 17 in accordance with embodiments of the present invention. FIG. 18 shows the immersive capture systems of points A-F. While the points are shown as spheres, it is readily appreciated that non-spherical images may be captured and used as well. For example, three cameras may be used. If the cameras have lenses of greater than 120 each, the overlapping portion may be discarded or used in the seaming process.

FIG. 19 shows the image capture perspectives with additional perspectives in accordance with embodiments of the present invention. By increasing the number of cameras arranged around the perimeter of the arena, the effective capture zone may be increase to a torus-like shape. FIG. 19 shows the outline of the shape with more cameras disposed between points A-F.

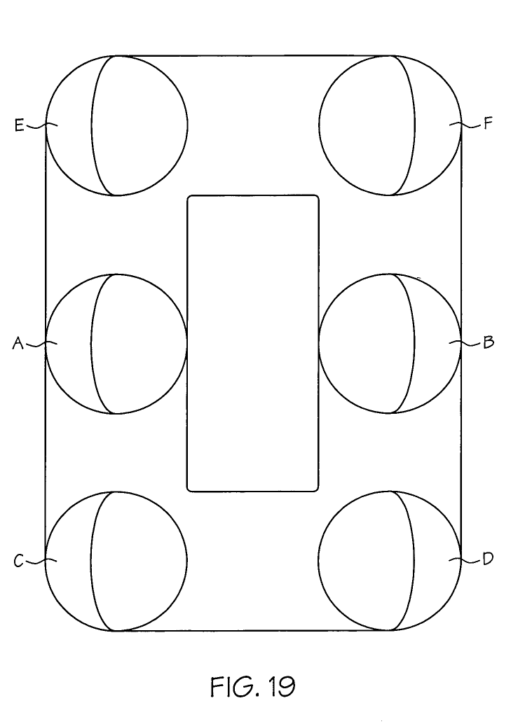

FIG. 20 shows another perspective of the system of FIG. 19 with a distribution system in accordance with embodiments of the present invention. The distribution system 2001 receives data from the various capture systems at the various viewpoints. The distribution system permits various ones of end users X, Y, and Z to view the event from the various capture positions. So, for example, one can view a game from the goal line every time the play occurs at that portion of the playing field.

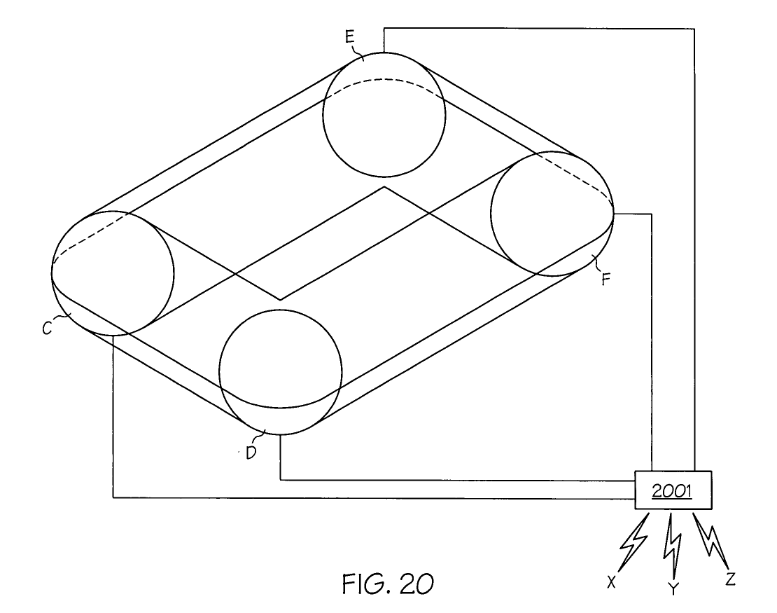

FIG. 21 shows an effective field of view concentrating on a playing field in accordance with embodiments of the present invention. The effective field of view concentrates on the playing field only in this embodiment. In particular, the effective viewing area created by the sum of all immersive viewing locations comprises the shape of a reverse torus.

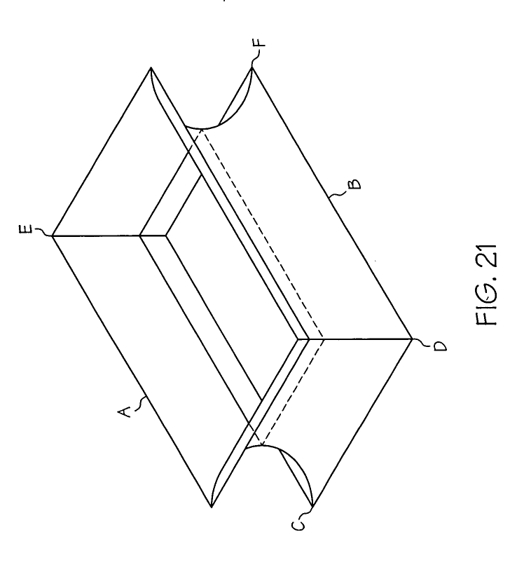

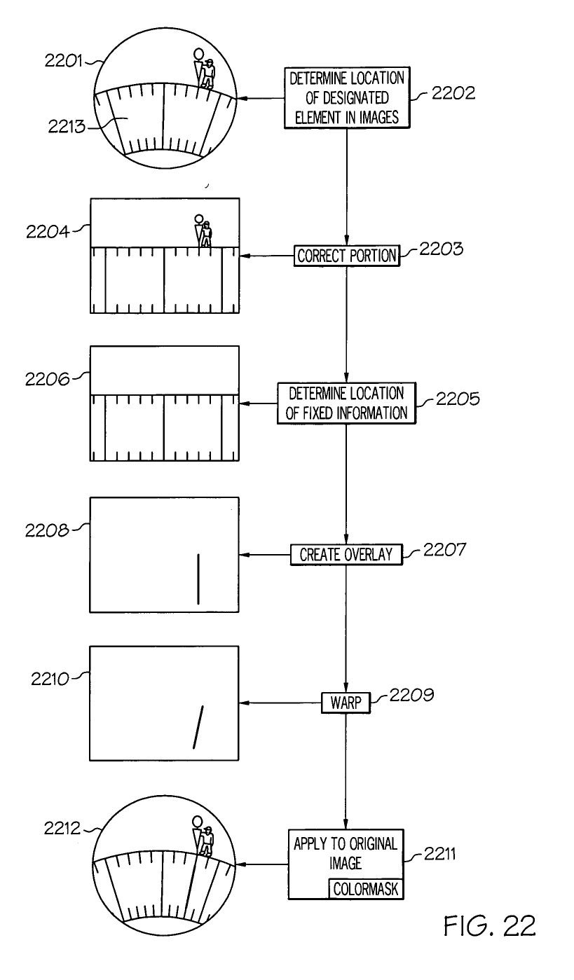

FIG. 22 shows a system for overlaying generated images on an immersive presentation stream in accordance with embodiments of the present invention. FIG. 22 shows a technique for adding value to an immersive presentation. An image is captured as shown in 2201. The system determines the location of designated elements in an image, for example, the flag marking the 10 yard line in football. The system may use known image analysis and matching techniques. The matching may be performed before or after perspective correcting a selected portion. Here, the system may use the detection of the designated element as the selected input control signal. The system next corrects the selected portion 2203 resulting in perspective corrected output 2204. The system, using similar image analysis techniques, determines the location of fixed information (in this example, the line markers) 2205 as shown in 2206 and creates an overlay 2207 to comport with the location of the designated element (the 10 yard line flag) and commensurate with the appropriate shape (here, parallel to the other line markers). The system next warps the overlay to fit to the shape of the original image 2201 as shown by step 2209 and resulting in image 2210. Finally, in step 2211, the overlay is applied to the original image resulting in image 2212. It is appreciated that a color mask may be used to define image 2210 so as to be transparent to all except the color of playing field 2213. Using this technique, a viewer would have a timely representation of the 10 yard marker despite looking in various directions as the marking line 2210 would be part of the immersive video stream shown to the end users. It is appreciated that the corrections may be performed before the game starts and have pre-stored elements 2210 ready to be applied as soon as the designated element is detected.

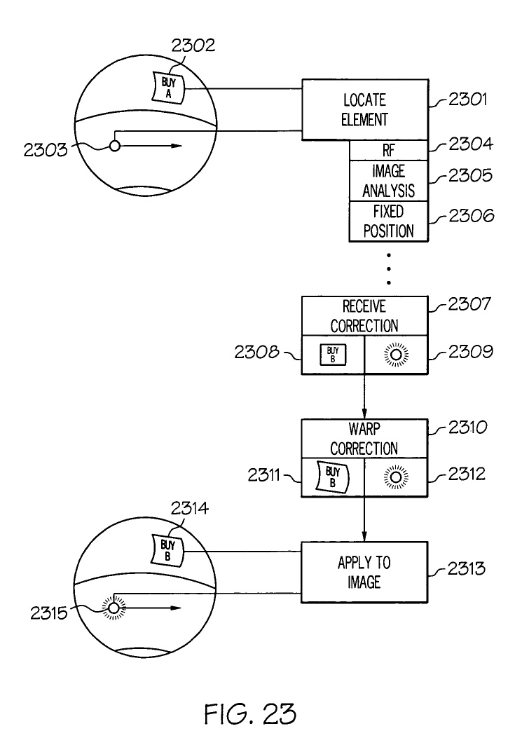

FIG. 23 shows an image processing system for replacing elements in accordance with embodiments of the present invention. FIG. 23 shows another value added way of transmitting information to end users. First, in step 2301, the system locates designated elements (here, advertisement 2302 and hockey puck 2303). The designated elements may be found by various means as known in the art, including, but not limited to, a radio frequency transmitter located within the puck and correlated to the image as captured by an immersive capture system 2304, by image analysis and matching 2305, and by knowing the fixed position of an advertisement 2302 in relation to an immersive video capture system. Next, a correction or replacement image for the elements 2302 and 2303 is pulled from a storage (not shown for simplicity) with corrected images being represented by 2308 and 2309. The corrected images are warped 2310 to fit the distortion of the immersive video portion at which location the elements are located (to shapes 2311 and 2312). Finally, the warped versions of the corrections 2311 and 2312 are applied to the image in step 2313 as 2314 and 2315. It is appreciated that fast moving objects may not need correction and distorting to increase video throughput of correcting images. Viewers may not notice the lack of correction to some elements 2315.

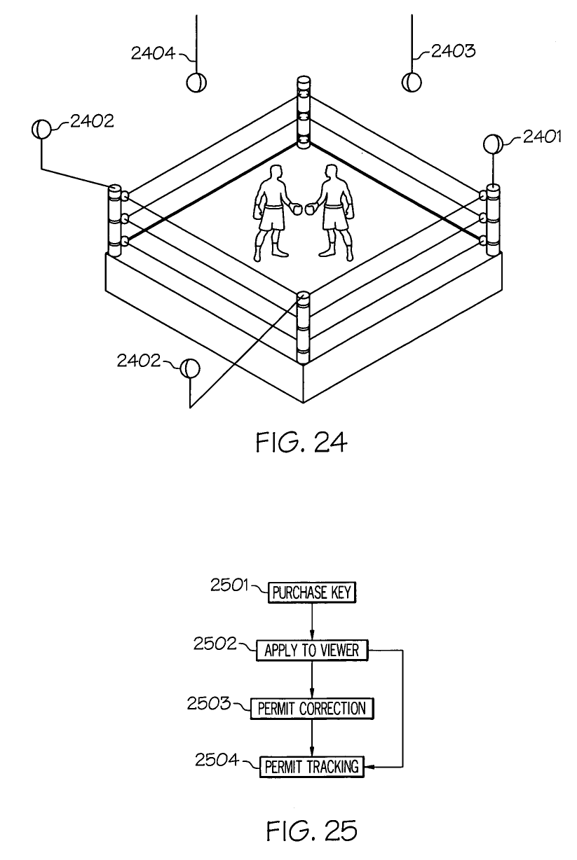

FIG. 24 shows a boxing ring in accordance with embodiments of the present invention. Here, immersive video capture systems are shown arranged around the boxing ring. The capture systems may be placed on a post of the ring 2401, suspended away from the ring 2403, or spaced from yet mounted to the posts 2402. Finally, a top level view may be provided of the whole ring 2404. The system may also locate the boxers and automatically shift views to place the viewer closest to the opponents.

FIG. 25 shows a pay-per-view system in accordance with embodiments of the present invention. First, a user purchases 2501 a key. Next, the user's system applies the key 2502 to the user's viewing software that permits perspective correction of a selected portion. Next the system permits selected correction 2503 based on user input. As a value added, the system may permit tracking of action of a scene 2504.

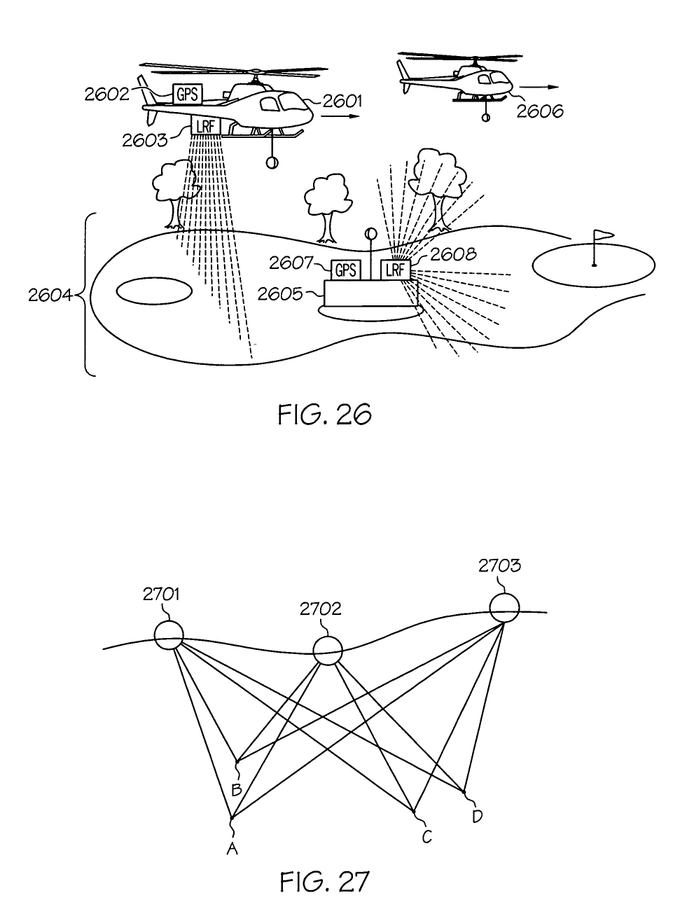

FIG. 26 shows various image capture systems in accordance with embodiments of the present invention. Aerial platform 2601 may contain GPS locator 2602 and laser range finder 2603. The aerial platform may comprise a helicopter or plane. The aerial platform 2601 flies over an area 2604 and captures immersive video images. As an alternative, the system may use a terrestrial based imaging system 2605 with GPS locator 2608 and laser range finder 2607. The system may use the stream of images captured by the immersive video capture system to compute a three dimensional mapping of the environment 2604.

FIG. 27 shows image analysis points as captured by the systems of FIG. 26 in accordance with embodiments of the present invention. The system captures images based on a given frame rate. Via the GPS receiver, the system can capture the location of where the image was captured. As shown in FIG. 27, the system can determine the location of edges and, by comparing perspective corrected portions of images, determine the distance to the edges. Once the two positions are known of 2701 and 2702, one may use known techniques to determine the locations of objects A and B. By using a stream of images, the system may verify the location of objects A and B with a third immersive image 2703. This may also lead to the determination of the locations of objects C and D.

Both platforms 2601 and 2608 may be used to capture images. Further, one may compute the distance between images 2701 and 2702 by knowing the velocity of the platform and the image capture rate. Systems disclosing object location include U.S. Pat. No. 5,694,531 and U.S. Pat. No. 6,005,984.

Further, one may use a second platform 2606 at a different time of the day to capture a slightly different image set of environment 2604. By having a different position of the sun, different edges may be revealed and captured. Using this time differential method, one may find edges not found in one single image. Further, one may compare the two 3D models and take various values to determine the locations of polygons in the data sets.

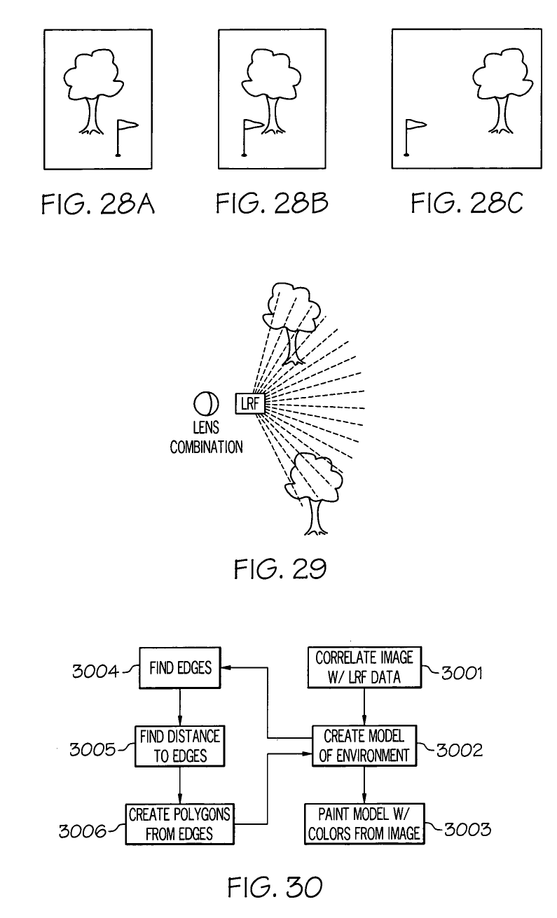

FIG. 28A shows an image 2701 taken at a first location. FIG. 28B shows 2702 captured at a second location. FIG. 28C shows 2703 taken at a third location.

FIG. 29 shows a laser range finder and lens combination scanning between two trees.

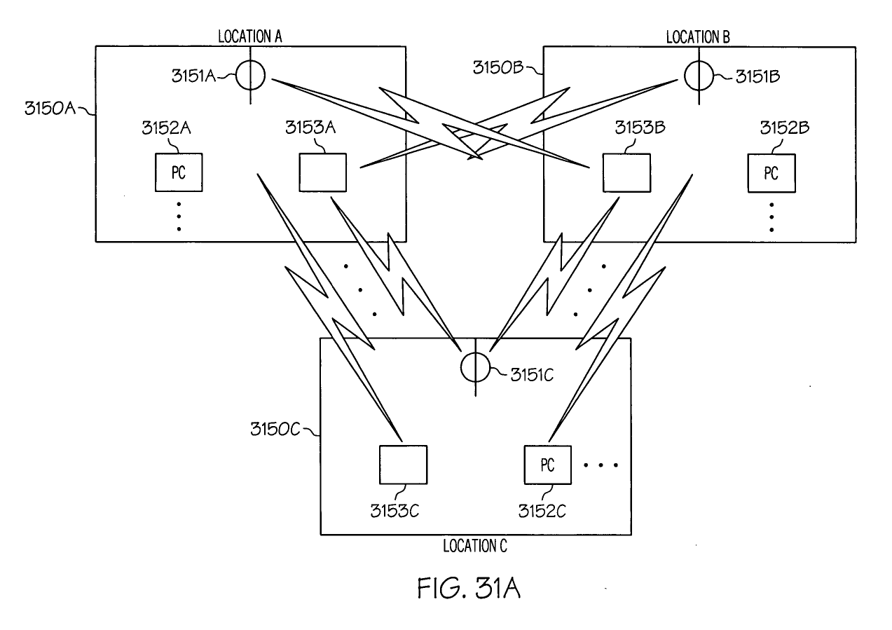

Moreover, as shown in FIG. 30, one may use a laser range finder to determine distances to elements on the side of the platform. The system correlates the images to the laser range finder data 3001. Next, the system creates a model of the environment 3002. First the system finds edges 3004. Next, the system find distances to the edges 3005. Next, the system creates polygons from the edges 3006. Next, the system paints the polygons with the colors and textures of a captured image 3003.

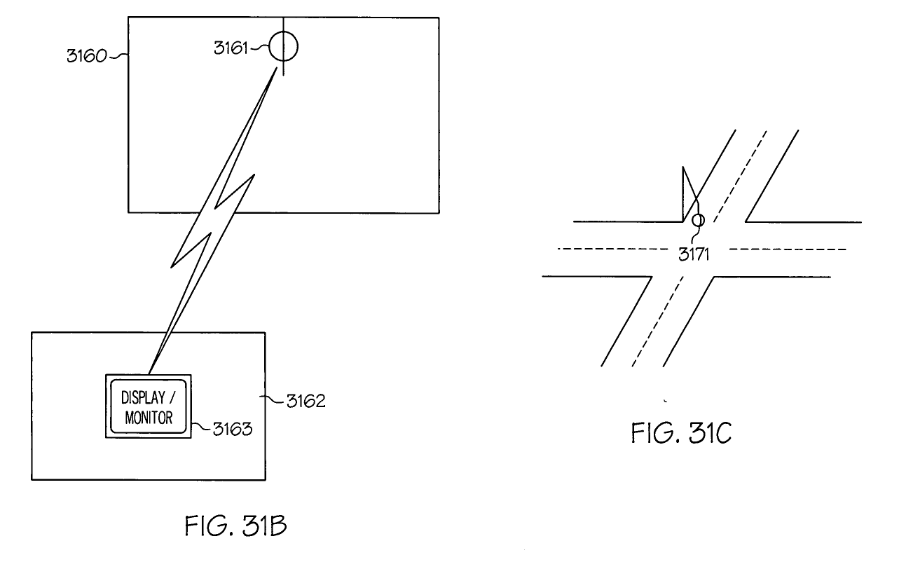

FIGS. 31A-C show a plurality of applications that utilize advantages of immersive video in accordance with the present invention. These applications include, e.g., remote collaboration (teleconferencing), remote point of presence camera (web-cam, security and surveillance monitoring), transportation monitoring (traffic cam), Tele-medicine, distance learning, etc.

Referring to FIG. 31A, an exemplary arrangement of the invention as used in teleconferencing/remote collaboration is shown. Locations A-N 3150A-3150N (where N is a plurality of different locations) may be configured for teleconferencing and/or remote collaboration in accordance with the invention. Preferably, each location includes, e.g., an immersive video capture apparatus 3151A-N (as describe in this and related applications), at least one personal computer (PC) including display 3152A-N and/or a separate remote display 3153A-N. The immersive video apparatus 3150 is preferably configured in a central location to capture real time immersive video images for an entire area requiring no moving parts. The immersive video apparatus 3151 may output captured video image signals received by a plurality of remote users at the remote locations 3150 via, e.g., the Internet, Intranet, or a dedicated teleconferencing line (e.g., an ISDN line). Using the invention, remote users can independently select areas of interest (in real time video) during a teleconference meeting. For example, a first remote user a location B 3150B can view an immersed video image captured by immersive video apparatus 3151A at location A 3150A. The immersed image can be viewed on a remote display 3153B and/or display coupled to PC 3152B. The first remote user can select areas of interest in the displayed immersed image for perspective corrected video viewing. The system produces the equivalent of pan, tilt, zoom, and rotation within a selected view, transforming a portion of the captured video image based upon user or pre-selected commands, and producing one or more output images that are in correct perspective for human viewing in accordance with the user selections. The perspective corrected image is further provided in real time video and may be displayed on remote display 3153 and/or PC display 3152. A second remote user at, e.g., location B 3150B or location N 3150N, can simultaneously view the immersed video image captured by the same immersive video apparatus 3151A at location A 3150A. The second user can view the immersed image on the remote display or on a second PC (not shown). The second remote user can select areas of interest in the displayed immersed image for perspective corrected video viewing independent of the first remote user. In this manner each user can independently view particular area of interest captured by the same immersive video apparatus 3151A without additional cameras and/or cameras conventionally requiring mechanical movements to capture images of particular areas of interest. PC 3153 preferably is configured with remote collaboration software (e.g., Collaborator by Netscape, Inc.) so that users at the plurality of locations 3150A-N can share information and collaborate on projects as is known. The remote collaboration software in combination permits plurality of users to share information and conduct remote conferences independent of other users.

Referring to FIG. 31B, an exemplary arrangement of the invention as used in security monitoring and surveillance is shown. In a preferred arrangement, a single immersive video capture apparatus 3161, in accordance with the invention, is centrally installed for surveillance. In this arrangement, the single apparatus 3161 can be used to monitor an open area of an interior of a building, or monitor external premises, e.g., a parking lot, without requiring a plurality of cameras or conventionally cameras that require mechanical movements to scan areas greater than the field of view of the camera lens. The immersive video image captured by the immersive video apparatus 3161 may be transmitted to a display 3163 at remote location 3162. A user at remote location 3162 can view the immersed video image on display or monitor 3163. The user can select area of particular interest for viewing in perspective corrected real time video.

Referring to FIG. 31C, an exemplary arrangement of the invention as used in transportation monitoring (e.g., traffic cam) is shown. In this configuration, an immersive video apparatus 3171, in accordance with the invention, is preferably located at a traffic intersection, as shown. It is desirable that the immersive video apparatus 3171 is mounted in a location such that entire intersection can be monitored in immersive video using only a single camera. In accordance with the invention, the captured immersive video image may be received at a remote location and/or a plurality of remote locations. Once the immersed video mage is received, the user or viewer of the image can select particular areas of interest for perspective corrected immersive video viewing. The immersive video apparatus 3171 produces the equivalent of pan, tilt, zoom, and rotation within a selected view, transforming a portion of the video image based upon user or pre-selected commands, and producing one or more output images that are in correct perspective for human viewing in accordance with the user selections. In contrast to conventional techniques, that require a plurality of cameras located in each direction (in some case multiple cameras in each direction), the present invention preferably utilizes a single immersive video apparatus 3171 to capture immersive video images in all directions.

Accordingly, there has been described herein a concept as well as several embodiments including a preferred embodiment of a pay-for-view display delivery system for delivering at least a selected portion of video images for an event wherein the event is captured via multiple streaming data streams and the delivery system delivers a display of at least one view of the event, selected by a pay-per-view user, using at least one portion of the multiple streaming data streams and wherein the event is captured using at least one digital wide angle/fisheye lens

Although the present invention has been described in relation to particular preferred embodiments thereof, many variations, equivalents, modifications and other uses will become apparent to those skilled in the art. It is preferred, therefore, that the present invention be limited not by the specific disclosure herein, but only by the appended claims.

1-55. (Canceled)

56. A method of determining the location of an object, the method comprising:
a) receiving an immersive video of an environment, the immersive video having been captured with a video image capture system having a wide angle field of view, the captured immersive video representing an immersive image;
b) perspectively correcting a portion of the captured immersive image in response to user selections;
c) displaying the perspectively corrected portion of the captured immersive image; and
d) determining the location of an object in the field of view with a laser range finder.

57. The method of claim 56, wherein the video image capture system comprises a fisheye lens.

58. The method of claim 56, wherein the laser range finder is located proximate to the video image capture system.

59. The method of claim 56, wherein said wide-angle field of view is a spherical field of view.

60. The method of claim 56, wherein the video image capture system is mounted to a movable platform.

61. The method of claim 60, wherein the platform comprises a flying machine.

62. The method of claim 60, wherein the platform comprises a terrestrial vehicle.

63. The method of claim 60, further comprising controlling movement of the platform remotely.

64. The method of claim 56, wherein the step of determining the location of the object comprises determining the location of the laser range finder, and the location of the object is determined relative to the location of the laser range finder.

65. The method of claim 64, wherein the location of the laser range finder is determined with a GPS device.

66. The method of claim 56, further comprising creating a three dimensional model of the environment.

67. An apparatus for determining the location of an object, the apparatus comprising:
a video image capture system having a wide angle field of view, the video image capture system being configured to capture an immersive video image of an environment; and
a laser range finder operable to determine the location of an object located within the field of view of the video image capture system.

68. The apparatus of claim 67, wherein the laser range finder is proximate to the video image capture system.

69. The apparatus of claim 67, wherein the video image capture system comprises a fisheye lens.

70. The apparatus of claim 67, further comprising a movable platform, wherein the video image capture system is mounted to the platform.

71. The apparatus of claim 70, the platform comprising a flying machine.

72. The apparatus of claim 70, further comprising a remote control operable to control movement of the platform.

73. The apparatus of claim 67, further comprising a processor in communication with the video image capture system and the laser range finder, the processor being configured to create a three dimensional model of the environment.

74. The apparatus of claim 67, wherein the immersive video image has a 360 degree field of view.

75. A method of determining the location of an object, the method comprising:
a) receiving an immersive video of an environment, the immersive video having been captured with a video image capture system having an extreme field of view exceeding 180 degrees; and
b) determining the location of the object in the field of view with a laser range finder.
